(19) United States
(12) Patent Application Publication
(10) Pub. No.: US 2004/0229018 A1
(43) Pub. Date: Nov. 18, 2004

(54) Complex microstructure film

(76) Inventors: Paul D Graham, Woodbury, MN (US); Mark F Schulz, Lake Elmo, MN (US)

Correspondence Address: 3M INNOVATIVE PROPERTIES COMPANY, PO BOX 33427, ST. PAUL, MN, 55133-3427, US

(21) Appl. No.: 10/483,881

(22) PCT Filed: May 16, 2003
(86) PCT No.: PCT/US03/15481

(51) Int. Cl. B32B 1/00

(52) U.S. Cl. 428/156; 428/141

(57) ABSTRACT

The present invention is directed to articles comprising a film having a first major surface and a second major surface, the first major surface comprising primary microstructure elements and secondary microstructure elements.

### FIELD OF THE INVENTION

The present invention relates to printable adhesive articles.

### BACKGROUND OF THE INVENTION

The present invention is related to printable adhesive articles. The present invention is especially useful for linerless adhesive tapes and labels. Images and printed matter including indicia, bar codes, symbols and graphics are common. Images and data that warn, educate, entertain, advertise or otherwise inform, etc. are applied on a variety of interior and exterior surfaces.

Techniques that may be used to print images and printed matter include thermal mass transfer printing (also known simply as thermal transfer printing), dot-matrix printing, laser printing, electrophotography (including photocopying) and inkjet printing. Inkjet can include printing by drop-on-demand inkjet or continuous inkjet techniques. Drop on demand techniques include piezo inkjet and thermal inkjet printing which differ in how the ink drops are created.

Inkjet inks can be organic-solvent based, aqueous (water-based) or solid (phase-change) inkjet inks. Solid inkjet inks have a solid wax or resin binder component. The ink is melted. The molten ink is then printed by inkjet.

The components of an inkjet system used for making graphics can be grouped into three major categories: the computer, software, and printer category, the ink category and the category of receptor medium.

The computer, software, and printer will control the size, number and placement of the ink drops and will transport the receptor medium through the printer. The ink will contain the colorant. The receptor medium provides a repository to accept and hold the ink. The quality of the inkjet image is a function of the total system.

The composition and interaction between the ink and receptor medium is most important in an inkjet system. With printers now exceeding 2400×2400 dpi resolution, inkjet drop size is smaller than in the past. A typical drop size for this dpi precision, is less than about 10 picoliters. Some printer makers are striving for even smaller drop sizes, while other printer makers are content with the larger drop sizes for large format graphics.

Containers, packages, cartons, and cases, (generally referred to as “boxes”) for storing and shipping products typically use box sealing tape, such as an adhesive tape, to secure the flaps or covers so that the box will not accidentally open during normal shipment, handling, and storage. Box sealing tape maintains the integrity of a box throughout its entire distribution cycle. Box sealing tape can be used on other parts of boxes and on other types of article. A typical box sealing tape comprises a plastic film backing with a printable surface and a pressure-sensitive adhesive layer. This tape can be printed and applied to a box to seal the box. It can also be printed, cut into a label and applied onto a box or article. These tapes can be made in roll or pad form, and can have information printed or otherwise applied to, or contained within or on, the tape.

These boxes generally display information about the contents. This information most commonly located on the box might include lot numbers, date codes, product identification information, and bar codes. The information can be placed onto the box using a number of methods. These include preprinting the box when it is manufactured, or printing this information onto the box at the point of use. Other approaches include the use of labels, typically white paper with preprinted information either applied manually, or with an online automatic label applicator.

A recent trend in conveying information related to the product is the requirement to have the information specific for each box. For example, each box can carry specific information about its contents and the final destination of the product, including lot numbers, serial numbers, and customer order numbers. The information is typically provided on tape or labels that are customized and printed on demand, generally at the point of application onto the box.

One system for printing information involves thermal transfer ink printing onto tape or labels using an ink ribbon and a special heat transfer print head. A computer controls the print head by providing input to the head, which heats discrete locations on the ink ribbon. The ink ribbon directly contacts the label so that when a discrete area is heated, the ink melts and is transferred to the label. Another approach using this system is to use labels that change color when heat is applied (direct thermal labels). In another system, variable information is directly printed onto a box or label by an inkjet printer including a print head. A computer can control the ink pattern sprayed onto the box or label.

Both thermal transfer and inkjet systems produce sharp images. With both inkjet and thermal transfer systems, the print quality depends on the surface on which the ink is applied. It appears that the best system for printing variable information is one in which the ink and the print substrate can be properly matched to produce a repeatable quality image, especially bar codes, that must be read by an electronic scanner with a high degree of reliability.

Regardless of the specific printing technique, the printing apparatus includes a handling system for guiding a continuous web of tape to the print head away from the print head following printing for subsequent placement on the article of interest (for example, a box). To this end, the web of tape is normally provided in a rolled form (“tape supply roll”), such that the printing device includes a support that rotatably maintains the tape supply roll. When the tape roll is linerless, the adhesive of the tape is in intimate contact with the printable surface of the next wrap of tape in the roll.

Examples of microstructured ink receptor media can be found in WO 99/55537, WO 00/73083, WO 00/73082, WO 01/58697 and WO 01/58698.

### SUMMARY OF THE INVENTION

Using a microporous or microstructured ink receptor adhesive article has created special problems. Generally, the ink or the ink receptive coating will wick to the corners between the surface and the microstructured elements because of capillary attraction. Therefore, less ink or ink receptive coating stays where it is coated and the optical density of the printed image is reduced. This results in a degradation of the quality and intensity of the printed image.

The present invention is directed to an adhesive article having a receptor medium comprising a complex microstructured surface that reduces the capillary attraction.

The present invention is directed to an article comprising a film having a first major surface and a second major surface, the first major surface comprising primary microstructure elements having walls and secondary microstructure elements having an x-direction dimension, wherein the secondary microstructured element x-direction dimension is at least 5 micrometers less than the height of the primary microstructure walls.

In another embodiment, the present invention is directed to an article comprising a film having a first major surface and a second major surface, the first major surface comprising primary microstructure elements and secondary microstructure elements, the secondary microstructure elements having a dimension in the x direction of less than 5 micrometers.

In another embodiment, the present invention is directed to an article comprising a film having a first major surface and a second major surface, the first major surface comprising primary microstructure elements and secondary microstructure elements, the secondary microstructure elements having a pitch of less than 10 micrometers.

In another embodiment, the present invention is directed to an article comprising a film having a first major surface and a second major surface, the first major surface comprising primary microstructure elements and secondary microstructure elements, wherein the secondary microstructure elements are non-cylindrical.

In another embodiment, the present invention is directed to an article comprising a film having a first major surface and a second major surface, the first major surface comprising primary microstructure elements and secondary microstructure elements, wherein the secondary microstructure elements are depressed microstructure elements.

In another embodiment, the present invention is directed to an article comprising a film having a first major surface and a second major surface, the first major surface comprising primary microstructure elements and secondary microstructure elements, the primary microstructure elements having at least two walls defining depressed microstructure elements and wherein the secondary microstructure extends between two walls of the primary microstructured elements.

In another embodiment, the present invention is directed to an article comprising a film having a first major surface and a second major surface, the first major surface comprising primary microstructure elements and at least two sets of intersecting secondary microstructure elements.

In another embodiment, the present invention is directed to an article comprising a film having a first major surface and a second major surface, the first major surface comprising primary microstructure elements defining a volume and secondary microstructure elements defining a volume, wherein ratio of the volume of the primary microstructure elements to the volume of the secondary microstructure elements is between about 35 and about 500.

### BRIEF DESCRIPTION OF THE DRAWINGS

FIG. 1 is a scanning electron microscopy of a cross sectional view of an embodiment of the present invention.

FIG. 2 is an optical micrograph of an elevated overhead view of an embodiment of the present invention.

FIG. 3 is an elevated view of a first embodiment of the present invention.

FIG. 4 is an elevated view of a second embodiment of the present invention.

FIG. 5 is a transverse cross-sectional view of the embodiment illustrated in FIG. 3 along line 5-5.

FIG. 6 is a cross-sectional view of an embodiment of the present invention including a multilayer structure.

### DETAILED DESCRIPTION OF THE INVENTION

For the purpose of the present invention, the following terms shall be defined:

“Microstructured element” means a recognizable geometric shape that either protrudes or is depressed.

“Microstructured surface” is a surface comprising microstructured elements.

“Primary microstructured element” means a microstructured element on a surface, the primary microstructured element having the largest scale of any microstructured element on the same surface.

“Secondary microstructured elements” means a smaller scale microstructured element on the same surface as the primary microstructured element.

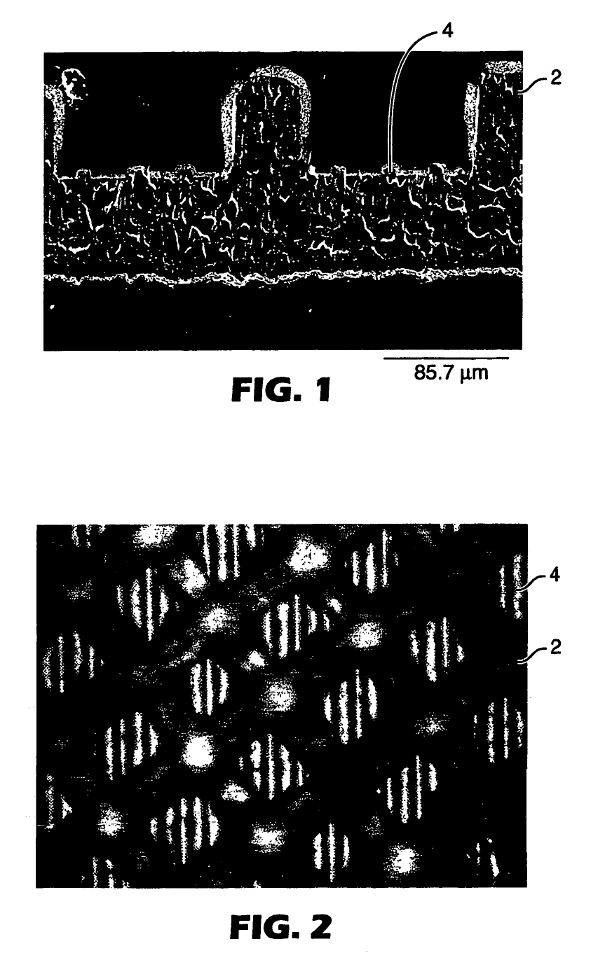

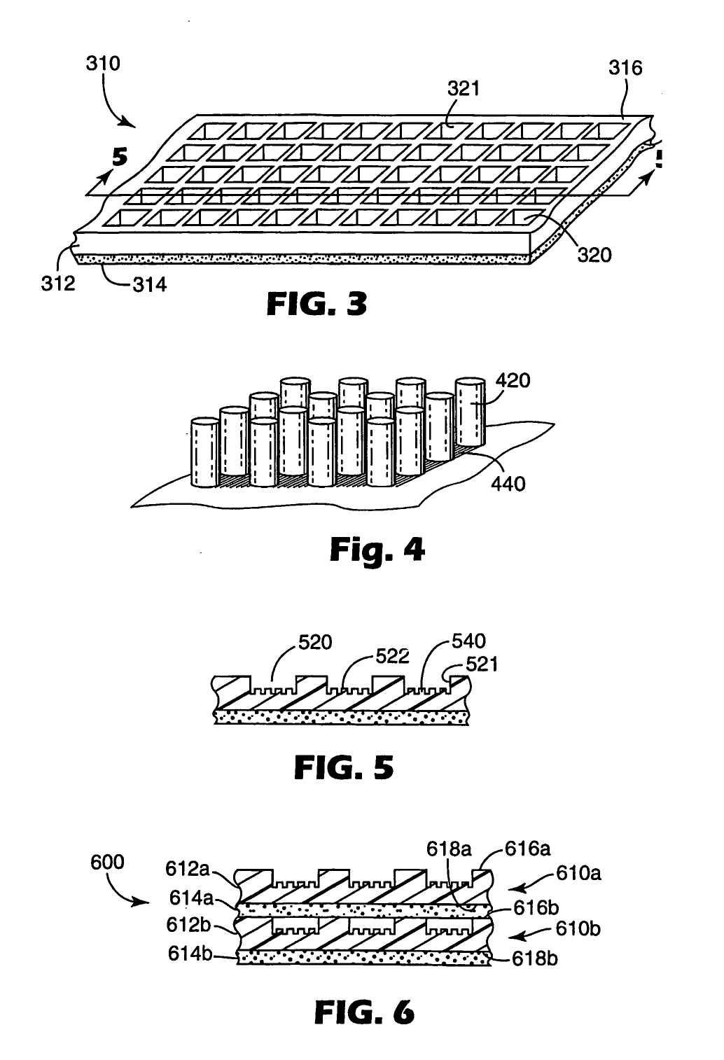

FIG. 1 illustrates a scanning electron microscopy image of an embodiment of the present invention. FIG. 2 illustrates an optical micrograph of an embodiment of the present invention. In FIGS. 1 and 2, the present invention comprises primary microstructure elements 2 and secondary microstructure elements 4. FIG. 3 illustrates an adhesive article embodying features of the invention. The adhesive article 310 comprises a microstructured backing 312 and an adhesive layer 314. The microstructured backing 312 comprises a first major surface 316 and a second major surface 318. In the embodiment illustrated in FIG. 3, the first major surface 316 of the microstructured backing comprises primary microstructured elements, in this case depressed microstructured elements 320, within the first major surface 316. The adhesive layer 314 is in contact with the second major surface 318 of the microstructured backing 312. The adhesive layer 314 may be a continuous layer or a discontinuous layer (e.g. stripes or dots of adhesive). The microstructured elements 320 have walls 321. The walls 321 illustrated in FIG. 3 are of a uniform height (x-direction dimension). However, in some embodiments, the wall height may be variable. For example, the walls 321 may have a shorter height in the center of the walls than at the corners. The walls 321 of the primary microstructure elements generally have a height of from about 5 to about 200 micrometers, for example between about 5 and about 100 micrometers. The walls of the primary microstructure elements generally have a thickness of between about 1 to about 50 micrometers, for example between about 1 and about 30 micrometers. In certain examples, the walls have a width of between about 5 and about 30 micrometers.

FIG. 4 illustrates a second embodiment of the present invention wherein the primary microstructured elements 420 are protruding cylindrical microstructured elements. FIG. 4 illustrates secondary microstructure elements 440.

In general, the geometrical configuration of the microstructured element is chosen to have sufficient capacity to control placement of an individual drop of ink. In some embodiments, the geometrical configuration is chosen such that the microstructured element pitch (that is, center to center distance between microstructured elements) is between about 1 and about 1000 micrometers, for example between about 10 and about 500 micrometers. In specific embodiments, the pitch is between about 50 and about 400 micrometers.

The microstructured elements may have any structure. For example, the structure for the microstructured element can range from the extreme of cubic elements with parallel vertical, planar walls, to the extreme of hemispherical elements, with any possible solid geometrical configuration of walls in between the two extremes. Specific examples include cube elements, cylindrical elements, conical elements with angular, planar walls, truncated pyramid elements with angular, planar walls, honeycomb elements and cube corner shaped elements. Other useful microstructured elements are described in PCT publications WO 00/73082 and WO 00/73083.

The pattern of the topography can be regular, random, or a combination of the two. “Regular” means that the pattern is planned and reproducible. “Random” means one or more features of the microstructured elements are varied in a non-regular manner. Examples of features that are varied include for example, microstructured element pitch, peak-to valley distance, depth, height, wall angle, edge radius, and the like. Combination patterns may for example comprise patterns that are random over an area having a minimum radius of ten microstructured element widths from any point, but these random patterns can be reproduced over larger distances within the overall pattern. The terms “Regular”, “Random” and “Combination” are used herein to describe the pattern imparted to the length of web by one repeat distance of the tool having a microstructured pattern thereon. For example, when the tool is a cylindrical roll, one repeat distance corresponds to one revolution of the roll. In another embodiment, the tool may be a plate and the repeat distance would be a plate and the repeat distance would correspond to one or both dimensions of the plate.

The volume (i.e., the void volume defined by a microstructure element) of a primary microstructured element can range from about 1 to about 20,000 pL, for example from about 1 to about 10,000 pL. Certain embodiments have a volume of from about 3 to about 10,000 pL, for example from about 30 to about 10,000 pL, such as from about 300 to about 10,000 pL. The volumes of the microstructured elements may decrease as printing technology leads to smaller ink drop size.

For applications in which desktop inkjet printers (typical drop size of 3-20 pL) will be used to generate the image, primary microstructured element volumes generally range from about 300 to about 8000 pL. For applications in which large format desktop inkjet printers (typical drop size of 10-200 pL will be used to generate the image, microstructured element volumes range from about 1,000 to about 10,000 pL.

Another way to characterize the structure of the primary microstructured elements 320 is to describe the microstructured elements in terms of aspect ratios. An “aspect ratio” is the ratio of the depth to the width of a depressed microstructured element or the ratio of height to width of a protruding microstructured element. Useful aspect ratios for a depressed microstructure element range from about 0.01 to about 2, for example from about 0.05 to about 1, and in specific embodiments from about 0.05 to about 0.8. Useful aspect ratios for a protruding microstructure element range from about 0.01 to about 15, for example from about 0.05 to about 10, and in specific embodiments from about 0.05 to about 8.

The overall height of the primary microstructured elements depends on the shape, aspect ratio, and desired volume of the microstructured element. The height of a 5 microstructured element can range from about 5 to about 200 micrometers. In some embodiments, the height ranges from about 20 to about 100 micrometers, for example about 30 to about 90 micrometers.

Primary microstructured element pitch is in the range of from 1 to about 1000 micrometers. Certain embodiments have a primary microstructured element pitch of from about 10 to about 500 micrometers, for example from about 50 to about 400 micrometers. The microstructured element pitch may be uniform, but it is not always necessary or desirable for the pitch to be uniform. It is recognized that in some embodiments of the invention, it may not be necessary, or desirable, that uniform microstructured element pitch be observed, nor that all features be identical. Thus, an assortment of different types of features, for example, microstructured elements with, perhaps, an assortment of microstructured element pitches may comprise the microstructured surface of the image transfer media according to the invention. The average peak to valley distances of individual elements is from about 1 to about 200 micrometers.

FIG. 5 shows a cross sectional view of the embodiment illustrated in FIG. 3 along the line 5-5. The microstructured elements 520 have a base surface 522 extending between the walls 521. The microstructured element base surface 522 comprises secondary microstructured elements 540. In the embodiment illustrated in FIG. 5, secondary microstructure elements 540 are defined within the microstructured element base surface 522. The secondary microstructure elements have dimensions in the x direction (generally perpendicular to the first major surface, e.g. depth of depressed microstructure elements or height of protruding elements), as well as a length and width. Generally, the x-direction dimension is between about 0.1 and about 50 micrometers, for example between about 0.1 and about 20 micrometers. In some embodiments, the x-direction dimension is between about 0.1 and about 10 micrometers, for example from about 0.1 and about 5 micrometers.

In some embodiments, the secondary microstructured element x-direction dimension is at least 5 micrometers less than the height of the primary microstructure walls. For example, the secondary microstructured element x-direction dimension is at least 20 micrometers less than the height of the primary microstructure walls. In specific embodiments, the secondary microstructured element x-direction dimension is at least 50 micrometers less than the height of the primary microstructure walls, for example 70 micrometers. The difference may be as much as 199 micrometers between the secondary microstructured element x-direction dimension and the height of the primary microstructure walls.

In certain embodiments, the secondary microstructure elements extend between at least two walls 521 of the microstructured elements. In those embodiments, the walls 521 may be adjacent walls or may by opposite walls. The secondary microstructure elements may form any pattern, such as any combination of parallel elements, nonparallel elements, or parallel and nonparallel elements. The secondary microstructured elements may intersect at any number of points, for example straight parallel elements, and elements that meet at 90 degree angles.

In certain embodiments, the secondary microstructure elements additionally have a volume (e.g., a volume defined by secondary microstructure elements that intersect at 90 degrees or a volume defined by the secondary microstructured elements and an intersection with the primary microstructure walls). In such embodiments, the ratio of the volume of the primary microstructure elements to the volume of one secondary microstructure elements is between about 5 to 2,000,000. For example, the ratio may be 50 to 1,000,000; 50 to 1,000,000; or 150 to 150,000. For a specific embodiment, the ratio is between about 35 to about 500.

Generally, the pitch of the secondary microstructure elements is between about 0.1 and 100 micrometers, for example between about 1 and about 50 micrometers. In some embodiments, the pitch of the secondary microstructure elements is between about 1 and about 40 micrometers. The volume of the secondary microstructure elements is generally between about 0.01 and about 300 pL, for example between about 0.01 and about 100 pL. In some embodiments, the volume of the secondary microstructure elements is between about 0.01 and about 50 pL, for example between about 0.01 and about 10 pL, and in further example between about 0.01 and about 1 pL. The walls of the secondary microstructure elements generally have a thickness of between about 1 to about 50 micrometers, for example between about 1 and about 30 micrometers. In certain examples, the walls have a width of between about 5 and about 30 micrometers.

FIG. 6 shows an embodiment of the present invention in a multilayer structure 600. FIG. 6 illustrates two layers of a multilayer structure with first adhesive article 610a and second adhesive article 610b. The first adhesive article 610a comprises a microstructured backing 612a and an adhesive layer 614a. The microstructured backing 612a comprises a first major surface 616a and a second major surface 618a. The second adhesive article 610b comprises a microstructured backing 612b and an adhesive layer 614b. The microstructured backing 612b comprises a first major surface 616b and a second major surface 618b. The first adhesive layer 614a is in direct contact with the first major surface of 616b of the second microstructured backing 612b. Therefore, in order to remove the first adhesive article 610a from the second adhesive article 610b, the first adhesive layer 614a releases from the first major surface of 616b of the second microstructured backing 612b.

Microstructured Backing

The microstructured backing typically comprises a polymer. The backing can be a solid film. The backing can be transparent, translucent, or opaque, depending on desired usage. The backing can be clear or tinted, depending on desired usage. The backing can be optically transmissive, optically reflective, or optically retroreflective, depending on desired usage.

Nonlimiting examples of polymeric films useful as backing in the present invention include thermoplastics such as polyolefins (e.g. polypropylene, polyethylene), poly(vinyl chloride), copolymers of olefins (e.g. copolymers of propylene), copolymers of ethylene with vinyl acetate or vinyl alcohol, fluorinated thermoplastics such as copolymers and terpolymers of hexafluoropropylene and surface modified versions thereof, poly(ethylene terephthalate) and copolymers thereof, polyurethanes, polyimides, acrylics, and filled versions of the above using fillers such as silicates, silica, aluminates, feldspar, talc, calcium carbonate, titanium dioxide, and the like. Also useful in the application are coextruded films and laminated films made from the materials listed above. More specifically, the microstructured backing is formed from polyvinyl chloride, polyethylene, polypropylene, and copolymers thereof.

Properties of the backing used in the present invention can be augmented with optional coatings that improve control of the ink receptivity of the microstructured surface of the backing. Any number of coatings are known to those skilled in the art. It is possible to employ any of these coatings in combination with the microstructured surface of the present invention.

One can employ a fluid management system having a variety of surfactants or polymers can be chosen to provide particularly suitable surfaces for the particular fluid components of the pigmented inkjet inks. Surfactants can be cationic, anionic, nonionic, or zwitterionic. Many types of surfactant are widely available to one skilled in the art. Accordingly, any surfactant or combination of surfactants or polymer(s) that will render a polymer surface hydrophilic can be employed.

These surfactants can be coated or otherwise applied onto the microstructured element surface of the microstructured elements in the microstructured surface. Various types of surfactants have been used in the coating systems. These may include but are not limited to fluorochemical, silicon and hydrocarbon-based ones wherein the said surfactants may be cationic, anionic or nonionic. Furthermore, the nonionic surfactant may be used either as it is or in combination with another surfactant, such as an anionic surfactant in an organic solvent or in a mixture of water and organic solvent, the said organic solvents being selected from the group of alcohol, amide, ketone and the like.

Various types of non-ionic surfactants can be used, including but not limited to: fluorocarbons, block copolymers of ethylene and propylene oxide to an ethylene glycol base, polyoxyethylene sorbitan fatty acid esters, octylphenoxy polyethoxy ethanol, tetramethyl decynediol, silicon surfactants and the like known to those skilled in the art.

A release coating (low adhesion backsize) may additionally be applied to the microstructured surface. The release coating may be a continuous layer or a discontinuous layer (e.g. stripes and dots.) The release coating may be applied to the entire microstructured surface, including the microstructured elements, or only to certain areas of the microstructured surface. For example, in embodiments comprising depressed microstructured elements, the release coating may be only applied to the surface and not within the microstructured elements. In some embodiments, a release material can be blended with the material used to make the microstructured backing and incorporated into the backing.

Other coating materials may be used which are intended to improve the appearance or durability of the printed image on the microstructured surface. For example, an inkjet receptor coating may be used. The inkjet receptor coating may comprise one or more layers. Useful ink receptive coatings are hydrophilic and aqueous ink sorptive. Such coatings include, but are not limited to, polyvinyl pyrrolidone, homopolymers and copolymers and substituted derivatives thereof, polyethyleneimine and derivatives, vinyl acetate copolymers, for example, copolymers of vinyl pyrrolidone and vinyl acetate, copolymers of vinyl acetate and acrylic acid, and the like, and hydrolyzed derivatives thereof; polyvinyl alcohol, acrylic acid homopolymers and copolymers; co-polyesters; acrylamide homopolymers and copolymers; cellulosic polymers; styrene copolymers with allyl alcohol, acrylic acid, and/or maleic acid or esters thereof, alkylene oxide polymers and copolymers; gelatins and modified gelatins; polysaccharides, and the like. If the targeted printer prints aqueous dye inks, then a suitable mordant may be coated onto the microstructured surface in order to demobilize or “fix” the dyes. Mordants that may be used generally consist of, but are not limited to, those found in patents such as U.S. Pat. No. 4,500,631; U.S. Pat. No. 5,342,688; U.S. Pat. No. 5,354,813; U.S. Pat. No. 5,589,269; and U.S. Pat. No. 5,712,027. One specific example of an inkjet receptor coating is a solution containing polyvinyl pyridine and copolymers thereof as described in copending U.S. provisional application No. 60/357863 filed Feb. 19, 2002. Various blends of these materials with other coating materials, for example a blend of a release agent and an inkjet receptor, listed herein are also within the scope of the invention.

Additionally, directly affecting the substrate by means generally known in the art may be employed in the context of this invention. For example, flame treated surfaces, corona treated surfaces(air and nitrogen), or surface dehydrochlorinated poly(vinyl chloride) could be made into a microstructured backing as a printable substrate.

Adhesive

The microstructured backing may be formed into an adhesive article by the addition of an adhesive layer on the second major surface of the microstructured backing. The adhesive may be a pressure sensitive adhesive. Any suitable pressure sensitive adhesive composition can be used for this invention. The pressure-sensitive adhesives can be any conventional pressure-sensitive adhesive that adheres to both the microstructured backing and to the surface receiving the adhesive article. The pressure sensitive adhesive component can be any material that has pressure sensitive adhesive properties including the following: (1) tack, (2) adherence to a substrate with no more than finger pressure, and (3) sufficient ability to hold onto an adherend. Furthermore, the pressure sensitive adhesive component can be a single pressure sensitive adhesive or the pressure sensitive adhesive can be a combination of two or more pressure sensitive adhesives.

Pressure sensitive adhesives useful in the present invention include, for example, those based on natural rubbers, synthetic rubbers, styrene block copolymers, polyvinyl ethers, poly (meth)acrylates (including both acrylates and methacrylates), polyolefins, and silicones.

The pressure sensitive adhesive may be inherently tacky. If desired, tackifiers may be added to a base material to form the pressure sensitive adhesive. Useful tackifiers include, for example, rosin ester resins, aromatic hydrocarbon resins, aliphatic hydrocarbon resins, and terpene resins. Other materials can be added for special purposes, including, for example, oils, plasticizers, antioxidants, ultraviolet (“UV”) stabilizers, hydrogenated butyl rubber, pigments, and curing agents.

In a specific embodiment, the pressure sensitive adhesive is based on styrene-isoprene-styrene block copolymer.

In one embodiment, the adhesive is a low-flow adhesive. A low-flow adhesive is taught in U.S. Application Serial No. 60/391,497, filed Jun. 25, 2002.

One specific embodiment of the invention has a fiber reinforced pressure sensitive adhesive as described in co-pending U.S. application Ser. No. 09/764,478, filed Jan. 17, 2001 and the continuation-in-part U.S. application Ser. No. 10/180,784, filed Jun. 25, 2002. In such an embodiment, any suitable pressure sensitive adhesive composition can be used as a matrix of adhesive for the fiber reinforced adhesive. The pressure sensitive adhesive may be a low-flow adhesive, but some pressure sensitive adhesives that are not low-flow adhesives may still be adequate as a matrix for the fiber reinforced pressure sensitive adhesive. The pressure sensitive adhesive is then reinforced with a fibrous reinforcing material. Various reinforcing materials may be used to practice the present invention. In specific embodiments, the reinforcing material is a polymer. In certain embodiments, the reinforcing material is elastomeric. Examples of the reinforcing material include an olefin polymer, such as ultra low density polyethylene.

Additional layers of adhesive may be included on the adhesive layer opposite the microstructured backing. For example, a second adhesive layer may be coated on the low flow adhesive layer. The second adhesive layer may or may not be a low flow adhesive. For example, an a second adhesive layer that is not a low flow adhesive may be beneficial in a thin layer to maximize the tack of the adhesive article.

Method of Manufacturing the Tape

The tape comprises a microstructured film and an adhesive layer. The microstructured film has a first major surface comprising a microstructured surface and a second major surface. The microstructured surface can be made in a number of ways, such as using casting, coating, or compressing techniques. For example, microstructuring the first major surface of the backing can be achieved by at least any of (1) casting a molten thermoplastic using a tool having a microstructured pattern, (2) coating of a fluid onto a tool having a microstructured pattern, solidifying the fluid, and removing the resulting film, or (3) passing a thermoplastic film through a nip roll to compress against a tool having a microstructured pattern. The tool can be formed using any of a number of techniques known to those skilled in the art, selected depending in part upon the tool material and features of the desired topography. Illustrative techniques include etching (for example, via chemical etching, mechanical etching, or other ablative means such as laser ablation or reactive ion etching, etc.), photolithography, stereolithography, micromachining, knurling (for example, cutting knurling or acid enhanced knurling), scoring or cutting, etc. Alternative methods of forming the microstructured surface include thermoplastic extrusion, curable fluid coating methods, and embossing thermoplastic layers which can also be cured.

The compressing method uses a hot press familiar to those skilled in the art of compression molding. The pressure exerted in the press typically ranges from about 48 kPa to about 2400 kPa. The temperature of the press at the mold surface typically ranges from about 100° C. to about 200° C., for example from about 110° C. to about 170° C.

The duration time in the press typically ranges from about one second to about 5 minutes. The pressure, temperature and duration time used depend primarily on the particular material being microstructured, and the type of microstructured element being generated as is known to those skilled in the art.

The process conditions should be sufficient to cause the material to flow and generally take the shape of the surface of the tool being used. Any generally available commercial hot press may be used.

The extrusion method involves passing an extruded material or preformed substrate through a nip created by a chilled roll and a casting roll engraved with an inverse pattern of the desired microstructure. Or, an input film is fed into an extrusion coater or extruder. A polymeric layer is hot-melt coated (extruded) onto the input film. The polymeric layer is then formed into a microstructured surface.

Single screw or twin screw extruders can be used. Conditions are chosen to meet the general requirements understood to one skilled in the art. For example, the temperature profile in the extruder can range from 100° C. to 250° C. depending on the melt characteristics of the resin. The temperature at the die ranges from 150° C. to 250° C. depending on the characteristics of the resin. The pressure exerted in the nip can range from about 140 to about 1380 kPa and preferably from about 350 to about 550 kPa. The temperature of the nip roll can range from about 5° C. to about 150° C., for example from about 10° C. to about 100° C., and the temperature of the cast roll can range from about 25° C. to about 100° C., for example about 40° C. to about 60° C. The speed of movement through the nip typically ranges from about 0.25 to about 10 meters/min, but generally will move as fast as conditions allow.

Calendering may be accomplished in a continuous process using a nip, as is known in the film handling arts. In the present invention, a web having a suitable surface, and having sufficient thickness to receive the desired microstructure pattern is passed through a nip formed by two cylindrical rolls, one of which has an inverse image to the desired structure engraved into its surface. The surface layer contacts the engraved roll at the nip. The web is generally heated to temperatures of from 100° C. up to 540° C. with, for example, radiant heat sources (for example, heat lamps, infrared heaters, etc.) and/or by use of heated rolls at the nip. A combination of heat and pressure at the nip (typically, 100 to 500 lb/inch (1.8 kg/centimeter to 9 kg/centimeter)) is generally used in the practice of the present invention.

The second major surface of the microstructured backing is adhesive coated with an adhesive composition as described above. This may be accomplished using any coating technique known in the art.

The resulting adhesive article may include a release liner on the adhesive layer (not shown), though a release liner is not necessary. Release liners are known and commercially available from a number of sources. Examples of release liners include silicone coated kraft paper, silicone coated polyethylene coated paper, silicone coated or non-coated polymeric materials such as polyethylene or polypropylene. The aforementioned base materials may also be coated with polymeric release agents such as silicone urea, fluorinated polymers, urethanes, and long chain alkyl acrylates.

Printed Article

The adhesive article described is desirable to print. The microstructured elements contain any ink receptive coating and any ink applied to the microstructured surface, resulting in a controlled image.

Method of Printing

The adhesive article may be printed by any method known in the art. Specifically, the present adhesive article may be placed into an ink-jet printer and printed at high speeds (i.e. speeds in excess of 5 cm/second) while maintaining a clean image.

The following examples further disclose embodiments of the invention.

### EXAMPLES

Test Methods

Optical Density

The optical density of a black image on a white substrate was measured. Optical densities were measured using an “X-RITE 504“ SpectroDensitometer (available from X-Rite Incorporated, Grandville, Mich.). An optical density value of near zero would be representative of a white substrate.

Bar Code Readings

Bar code readings and grades were made using PC 600 Quickcheck Verifier (available from PSC Inc., Webster, N.Y.) according to American National Standards Institute (ANSI) X3.182. A bar code reading a “A” represents the highest rating possible using this standard.

Microscopy

Images of the microstructure film were obtained using Optical Microscopy at a magnification of from about 70 to about 200×. Cross-section images were obtained using SEM technique at a magnification of 350×.

### Example 1

A microstructured film was prepared which exhibited a pattern of recesses having ridges along the bottom surface of the recesses, the ridges having a lower height than the walls forming the recesses. More specifically, a 92:8 (w:w) mixture of a clear polypropylene resin (Dow 7C50, a high impact polypropylene copolymer having a melt flow rate (230° C./2.16 kg load) of about 8 g/10 minutes, available from Dow Chemical Company, Midland, Mich.), and a white pigmented polypropylene resin (a 1:1 blend by weight of titanium dioxide and a polypropylene resin having a typical melt flow rate of 2.7 g/10 minutes (230° C./2.16 kg), available from Exxon-Mobil) were extruded between two heated nip rollers located in close proximity to the die using a Killion single screw extruder (available from Davis Standard Killion, Pawcatuck, Conn.). The extruder had a diameter of 3.18 centimeters (cm) (1.25 inches), and five heated zones which were set as follows: Zone 1, 124° C (255° F.); Zone 2, 177° C. (350° F.); Zone 3, 235° C. (455° F.); Zone 4, 243° C. (470° F.); and Zone 5, 249° C. (480° F.). The die temperature was set at 249° C. (480° F.). The molten resin exited the die and was drawn between two nip rollers closed under pressure. The upper nip roll was a rubber coated roll and the lower nip roll was a metal tool roll having a microstructured pattern engraved on its surface. The nip rolls both had a diameter of approximately 30.5 cm (12 inches) and were hollow to permit heating or chilling of the rolls by passing a fluid through their interiors. The setpoint of the upper roll was 38° C. (100° F.) and the setpoint of the lower roll was 110° C. (230° F.). The web speed was between approximately 3.0 and 3.7 meters/minute (9.8 to 12.1 feet/minute).

The metal tool roll was engraved with three sets of grooves. There were two sets of parallel grooves, which were perpendicular to each other and are referred to hereinafter as the major grooves. These two perpendicular sets of helical grooves ran at an angle of approximately 45° to the roll axis, and had a depth of approximately 35 micrometers (microns, or μm), a width of approximately 10 μm at the bottom and 18 μm at the top, and were spaced approximately 250 μm apart. The third set of rounded grooves, hereinafter referred to as the minor grooves, ran at an angle of approximately 90° to the roll axis (i.e., parallel to the web direction) and had a depth about 2 micrometers, a width of approximately 20 μm at the top, and he pitch of the grooves was approximately 20 μm.

The microstructured surface of the tool roll embossed the extruded polypropylene resin to provide a polypropylene film having a first major surface with a microstructured pattern thereon, and a second major surface. The embossed film cooled prior to reaching a windup roll. The embossed pattern on the film comprised wells or recesses formed by walls. The recesses were rhomboidal in shape with a nominal depth of 35 μm, and the walls lay at 45° to the machine direction (web direction) of the microstructured film. In addition, the bottom of the recesses contained rounded ridges having a nominal height of about 2 μm with a which ran at an angle of 45° to the direction of the walls of the recesses (that is, they ran parallel to the web direction) and the pitch of the grooves was approximately 20 micrometers.

The film thus obtained, having a total thickness of about. 0.009 inches (124 micrometers), was provided with a water-based ink receptive coating on its microstructured surface.

The following three compositions were prepared. Unless otherwise stated, all parts are parts by weight.

Composition A: About 2 parts of glacial acetic acid was added to ten parts of REILLINE 420 SOLUTION (a solution of poly(4-vinylpyridine) obtained from Reilly Industries, Indianapolis, Ind.) followed by about 34 parts of isopropyl alcohol then about 34 parts of water. The solution was mixed after each component was added.

Composition B: About 110 parts of water were added to about 10 parts of “FREETEX 685” (a concentrated dye fixative containing a cationic, polyamine, available from Noveon, Inc., Cleveland, Ohio) and mixed.

Composition C: About 97.5 parts of ethanol were added to about 2.5 parts of “HELOXYTM MODIFER 48” (a low viscosity aliphatic triglycidyl ether, available from Resolution Performance Products, Houston, Tex.) and mixed.

A coating composition was prepared by mixing about 49 parts of Composition A, about 49 parts of Composition B and about 2 parts of Composition C. The coating composition was applied to the corona treated, microstructured surface of the film backing. The composition was applied with a #36 Mayer rod (available from R D Specialties of Webster, N.Y.) giving a nominal wet coating thickness of 81 micrometers above the top of the major walls. The coated film was dried in a convection oven for five minutes at about 70° C.

The coated film was then printed using a PL640L printer (available from Canon-Aptex, Tokyo, Japan) and employing a test pattern designed to evaluate monochrome readability and including bar codes, alphanumeric characters of various sizes, as well as black-on-white and white-on-black patterns. The printed film was evaluated for optical density as described in the test methods above. The optical density was about 1.32. Evaluation using a bar code reader gave a “Grade A” result.

### Example 2

Example 1 was repeated with the following modifications. The polymer melt mixture employed contained an 83:17 (w:w) mixture of a clear polypropylene resin (FINA 3376, a polypropylene homopolymer resin with calcium stearate having a melt flow rate (230° C./2.16 kg) of between about 2.5 and about 3.1 g/10 minutes, a Hunter Color “b” of 2.0 or less, and xylene solubles of between about 3.5 and 4.5%, obtained from ATOFINA Petrochemical Company, Dallas, Tex.) and a white pigmented polypropylene resin (a 1:1 blend by weight of titanium dioxide and PP4792 E1, a polypropylene resin having a typical melt flow rate of 2.7 g/10 minutes (230° C./2.16 kg), available from ExxonMobil Chemical, Houston, Tex.).

The major grooves had a depth of approximately 75 micrometers (microns, or μm), a width of approximately 18 μm at the bottom and 31 μm at the top, and were spaced approximately 125 μm apart. The minor grooves, hereinafter referred to as the minor grooves, ran at an angle of approximately 90° to the roll axis (i.e., parallel to the web direction) and had a depth of between about 8 and about 10 micrometers, a width of approximately 8 μm at the bottom and 11 μm at the top, and were spaced approximately 35 μm apart.

The embossed pattern on the film comprised wells or recesses formed by walls. The recesses were rhomboidal in shape with a nominal depth of 75 μm, and the walls lay at 45° to the machine direction (web direction) of the microstructured film. In addition, the bottom of the recesses contained ridges having a nominal height of between 8 and 10 μm, were spaced approximately 35 μm apart and which ran at an angle of 45° to the direction of the walls of the recesses (that is, they ran parallel to the web direction). The film thus obtained had a total thickness of 0.0053 inches (135 micrometers).

Example 2 was then printed and evaluated for optical density. The optical density was about 1.02.

### Example 3

Example 2 was repeated with the following modifications. A three-layer film was extruded. Each extruded layer was an 83:17 (w:w) polymer melt blend of clear polypropylene resin (Homopolymer 4018 Injection Molding Resin available from BP Amoco Polymers, Naperville, Ill.) and a white pigmented polypropylene resin (a 1:1 blend by weight of titanium dioxide and PP4792 E1, a polypropylene resin available from ExxonMobil Chemical, Houston, Tex.).

The minor grooves had a nominal height of about 4 to about 6 micrometers.

The film thus obtained had a total thickness of about 0.0053 inches (135 micronmeters). The coated microstructured film exhibited an optical density of 0.78.

### Example 4

Example 3 was repeated with the following modifications. The first (top) extruded layer was clear polypropylene resin (Homopolymer 4018 Injection Molding Resin available from BP Amoco Polymers, Naperville, Ill.) and the second (middle) and third (bottom) layers were a 75:25 (w:w) polymer melt blend of clear polypropylene resin (Homopolymer 4018 Injection Molding Resin available from BP Amoco Polymers, Naperville, Ill.) and a white pigmented polypropylene resin (a 1:1 blend by weight of titanium dioxide and PP4792 E1, a polypropylene resin available from ExxonMobil Chemical, Houston, Tex.).

The film thus obtained had a total thickness of about 0.005 inches (135 micrometers) with the pigmented layers accounting for about 0.0012 inches (30.5 micrometers) of the total. The coated microstructured film exhibited an average optical density of about 1.05.

### Example 5

A microstructured film was prepared which exhibited a pattern of recesses having ridges along the bottom surface of the recesses, the ridges having a lower height than the walls forming the recesses. More specifically, a 5:1 (w:w) mixture of a clear polypropylene resin (Dow 7C50, a high impact polypropylene copolymer having a melt flow rate (230° C./2.16 kg load) of about 8 g/10 minutes, available from Dow Chemical Company, Midland, Mich.), and a white pigmented polypropylene resin (a 1:1 blend by weight of titanium dioxide and a polypropylene resin having a typical melt flow rate of 2.7 g/10 minutes (230° C./2.16 kg), available from Exxon-Mobil) were extruded between two heated nip rollers located in close proximity to the die using a Killion single screw extruder (available from Davis Standard Killion, Pawcatuck, Conn.) . The extruder had a diameter of 3.18 centimeters (cm) (1.25 inches), and five heated zones which were set as follows: Zone 1, 124° C. (255° F.); Zone 2, 177° C. (350° F.); Zone 3, 235° C. (455° F.); Zone 4, 243° C. (470° F.); and Zone 5, 249° C. (480° F.). The die temperature was set at 249° C. (480° F.). The molten resin exited the die and was drawn between two nip rollers closed under pressure. The upper nip roll was a rubber coated roll and the lower nip roll was a metal tool roll having a microstructured pattern engraved on its surface. The nip rolls both had a diameter of approximately 30.5 cm (12 inches) and were hollow to permit heating or chilling of the rolls by passing a fluid through their interiors. The setpoint of the upper roll was 38° C. (100° F.) and the setpoint of the lower roll was 110° C. (230° F.). The web speed was between approximately 3.0 and 3.7 meters/minute (9.8 to 12.1 feet/minute).

The metal tool roll was engraved with four sets of grooves. There were two sets of parallel grooves, which were perpendicular to each other and are referred to hereinafter as the major grooves. These two perpendicular sets of helical grooves ran at an angle of approximately 45° to the roll axis, and had a depth of approximately 80 micrometers (microns, or μm), a width of approximately 18 μm at the bottom and approximately 39 μm at the top, and were spaced approximately 250 μm apart. A third set of grooves ran at an angle of approximately 90° to the roll axis, and had a depth of between approximately 2 and approximately 4 micrometers (microns, or μm), a width of approximately 5 μm at the bottom and approximately 7 μm at the top, and were spaced approximately 25 μm apart. A fourth set of grooves ran at a direction parallel to the roll axis, and had a depth of between approximately 5 micrometers (microns, or μm), a width of approximately 5 μm at the bottom and approximately 7 μm at the top, and were spaced approximately 25 μm apart. The third and fourth set of grooves are collectively referred to as the minor grooves.

The microstructured surface of the tool roll embossed the extruded polypropylene resin to provide a polypropylene film having a first major surface with a microstructured pattern thereon, and a second major surface. The embossed film cooled prior to reaching a windup roll. The embossed pattern on the film comprised wells or recesses formed by walls. The recesses were rhomboidal in shape with a nominal depth of 80 μm, and the walls lay at 45° to the machine direction (web direction) of the microstructured film. In addition, the bottom of the recesses contained two sets of ridges, the first having a nominal height of about 2 to about 5 μm and the second set having a nominal height of about 5 micrometers. The two sets of minor grooves ran at an angle of 90° to each other and the first set ran parallel to the web direction and the second set ran at an angle of 90° to the web direction and the minor groove pitch was 25 micrometers for both sets.

The film thus obtained, having a total thickness of about. 0.0055 inches (140 micrometers), was provided with a water-based ink receptive coating on its microstructured surface.

The following three compositions were prepared. Unless otherwise stated, all parts are parts by weight.

Composition A: 2 parts of glacial acetic acid was added to ten parts of REILLINE 420 SOLUTION (a solution of poly(4-vinylpyridine) obtained from Reilly Industries, Indianapolis, Ind.) followed by 14 parts of ethyl alcohol then 14 parts of water. The solution was mixed after each component was added.

Composition B: 20 parts of water and 20 parts of ethyl alcohol were added to 10 parts of “FREETEX 685” (a concentrated dye fixative containing a cationic polyamine, available from Noveon, Inc., Cleveland, Ohio) and mixed.

Composition C: 97.5 parts of ethanol were added to 2.5 parts of “HELOXY™ MODIFIER 48” (a low viscosity aliphatic triglycidyl ether, available from Resolution Performance Products, Houston, Tex.) and mixed.

Composition C: 97.5 parts of ethanol were added to 2.5 parts of “HELOXY™ MODIFIER 48” (a low viscosity aliphatic triglycidyl ether, available from Resolution Performance Products, Houston, Tex.) and mixed.

A coating composition was prepared by mixing 49 parts of Composition A, 49 parts of Composition B and 2 parts of Composition C. The coating composition was applied to the corona treated, microstructured surface of the film backing. The composition was applied with a #10 Mayer rod (available from R D Specialties of Webster, N.Y.) giving a nominal wet coating thickness of 22.5 micrometers above the top of the major walls. The coated film was dried in a convection oven for five minutes at about 70° C.

The coated film was then printed using a PL640L printer (available from Canon-Aptex, Tokyo, Japan) and employing a test pattern designed to evaluate monochrome readability and including bar codes, alphanumeric characters of various sizes, as well as black-on-white and white-on-black patterns. The printed film was evaluated for optical density as described in the test methods above. The optical density was 1.01. Evaluation using a bar code reader gave a “Grade B” result.

Various modifications and alterations of the present invention will become apparent to those skilled in the art without departing from the spirit and scope of the invention.

1. An article comprising a first major surface, the first major surface comprising primary microstructure elements having an x-direction dimension and secondary microstructure elements having an x-direction dimension, wherein the secondary microstructured element x-direction dimension is at least about 5 micrometers less than the primary microstructure element x-direction dimension.

2. The article of claim 1 wherein the secondary microstructured element x-direction dimension is at least about 50 micrometers less than the primary microstructure element x-direction dimension.

3. The article of claim 1 wherein the secondary microstructured element x-direction dimension is at least about 70 micrometers less than the primary microstructure element x-direction dimension.

4. The article of claim 1 wherein the primary microstructure elements are truncated pyramids.

5. The article of claim 1 wherein a base surface extends between the primary microstructured elements, and the base surface defines the secondary microstructure elements.

6. The article of claim 5 wherein the primary microstructure elements have walls defining the microstructure element, and the secondary microstructure elements extend from one wall to a second wall.

7. An article comprising a first major surface, the first major surface comprising primary microstructure elements and secondary microstructure elements, the secondary microstructure elements having a dimension in the x direction of less than 5 micrometers.

8. The article of claim 7 wherein the secondary microstructure elements have a dimension in the x direction of between about 0.1 and about 5 micrometers

9. The article of claim 7 wherein the secondary microstructure elements are cubic.

10. The article of claim 7 wherein a base surface extends between the primary microstructured elements, and the base surface defines the secondary microstructure elements.

11. The article of claim 10 wherein the primary microstructure elements have walls defining the microstructure element, and the secondary microstructure elements extend from one wall to a second wall.

12. An article comprising a first major surface, the first major surface comprising primary microstructure elements and secondary microstructure elements, the secondary microstructure elements having a pitch of less than 100 micrometers.

13. The article of claim 12 wherein a base surface extends between the primary microstructured elements, and the base surface defines the secondary microstructure elements.

14. The article of claim 13 wherein the primary microstructure elements have walls defining the microstructure element, and the secondary microstructure elements extend from one wall to a second wall.

15. An article comprising a first major surface, the first major surface comprising primary microstructure elements and secondary microstructure elements, wherein the secondary microstructure elements are non-cylindrical.

16. The article of claim 15 wherein the secondary microstructure elements are cubic elements.

17. The article of claim 15 wherein the secondary microstructure elements are honeycomb elements.

18. The article of claim 15 wherein the secondary microstructure elements are truncated pyramid elements.

19. The article of claim 15 wherein a base surface extends between the primary nicrostructured elements, and the base surface defines the secondary microstructure elements.

20. The article of claim 19 wherein the primary microstructure elements have walls defining the microstructure element, and the secondary microstructure elements extend from one wall to a second wall.

21. An article comprising a first major surface, the first major surface comprising primary microstructure elements and secondary microstructure elements, wherein the secondary microstructure elements are depressed microstructure elements.

22. The article of claim 21 wherein a base surface extends between the primary microstructured element walls, and the base surface defines the secondary microstructure elements.

23. The article of claim 22 wherein the primary microstructure elements have walls defining the microstructure element, and the secondary microstructure elements extend from one wall to a second wall.

24. The article of claim 21 wherein the secondary microstructure elements have a volume between about 0.01 and about 300 picoliters.

25. An article comprising a first major surface, the first major surface comprising primary microstructure elements and secondary microstructure elements, the primary microstructure elements having at least two walls defining depressed microstructure elements and wherein the secondary microstructure element extends between two walls of the primary microstructured elements.

26. The article of claim 25 wherein a base surface extends between the primary microstructured elements, and the base surface defines the secondary microstructure elements.

27. An article comprising a first major surface, the first major surface comprising primary microstructure elements and at least two sets of intersecting secondary microstructure elements.

28. An article comprising a first major surface, the first major surface comprising primary microstructure elements defining a volume and secondary microstructure elements defining a volume, wherein ratio of the volume of the primary microstructure elements to the volume of the secondary microstructure elements is between about 35 and about 500.
